(19) United States
(12) Patent Application Publication
(10) Pub. No.: US 2026/0070101 A1
(43) Pub. Date: Mar. 12, 2026

(54) POLYETHYLENE TEREPHTHALATE COMPOSITIONS AND METHODS

(71) Applicant: StokedPlastics Inc., Venice, CA (US)

(72) Inventors: James Merrill, Venice, CA (US); Drew Sfirri, Brunswick, ME (US); Tymur Sabirov, New York, NY (US); Asheesh Lanba, Westbrook, ME (US)

(73) Assignee: StokedPlastics Inc., Venice, CA (US)

(21) Appl. No.: 19/323,931

(22) Filed: Sep. 9, 2025

Related U.S. Application Data
(60) Provisional application No. 63/692,702, filed on Sep. 9, 2024.

(51) Int. Cl. B09B 3/40; B29B 7/08; B29B 11/08; B29B 13/02; B29B 13/06; B29B 13/10; B29K 67/00; B29K 105/26; C08L 67/03

(52) U.S. Cl. CPC B09B 3/40; B29B 7/08; B29B 11/08; B29B 13/022; B29B 13/06; B29B 13/10; C08L 67/03; B29K 2067/003; B29K 2105/26; C08L 2205/025; C08L 2207/20

(57) ABSTRACT

The disclosed technology relates to plastics recycling, and more specifically, to polyethylene terephthalate (PET) blend compositions and methods for increasing the recyclability of post-consumer plastics waste in injection molded hard goods. In some embodiments, the PET blend composition including virgin polyethylene terephthalate (vPET), recycled polyethylene terephthalate (rPET), and a polyester-based chain extender. In some embodiments, the composition is a PET blend composition including approximately 25-50% by weight of rPET, approximately 47-75% by weight of vPET, and approximately 0-3% by weight of the polyester-based chain extender.

### CROSS-REFERENCE TO RELATED APPLICATIONS

This patent application claims priority to U.S. Provisional Patent Application No. 63/692,702, filed Sep. 9, 2024, which is incorporated by reference in its entirety.

### TECHNICAL FIELD

The present disclosure relates generally to plastics recycling, and more specifically, to polyethylene terephthalate blend compositions and methods.

### BACKGROUND OF CERTAIN ASPECTS OF THE DISCLOSURE

The global plastic waste epidemic poses a significant environmental challenge, with an increasing volume of single-use plastics ending up in landfills and oceans. Globally, over 460 million metric tons of plastic waste are produced every year, of which 14 million tons of plastic end up in the ocean, resulting in an estimated loss of $2.5 trillion in forfeited feedstock, waterway disturbances and environmental cleanup. Less than 10% of the roughly 7 billion tons of plastic waste generated globally has been recycled.

Plastic waste amounts to 80% of all marine pollution. Such waste is a major cause of biodiversity loss and ecosystem degradation. It is estimated that there will be more plastic in the oceans than there are fish by 2050.

Recent research has also shown clear links from plastics to human health, food and water safety. Microplastics from plastic pollution have been found in almost every part of the human body, including breast milk, the placenta, testicles, hearts, livers, and kidneys. Microplastics are omnipresent in human food of both plant and animal origin, food additives, drinks and plastic food packaging, which are known to cause health hazards such as gastrointestinal disorders, cancers, worsening immune systems, respiratory issues, infertility and changes in chromosomes.

Plastic pollution is also linked to climate change. Plastic contributes to greenhouse gas (GHG) emissions throughout its life cycle, as a byproduct of fossil fuel refinement, to industrial production of plastic components and finally as landfill contributors that results in greenhouse landfill gases. Further, the spread of plastic pollution is worsened by extreme weather and floods that come from climate change. Furthermore, plastic pollution and climate change directly affect marine environments, impacting ocean ecosystems.

A large portion of mismanaged plastic waste is attributed to plastic bottles, which are made of polyethylene terephthalate (PET). Globally, it is estimated that one million plastic bottles are purchased every minute that are produced from fossil fuel-based virgin PET (vPET). Fossil fuel-based vPET is PET plastic that is made directly from fossil fuel-derived raw materials and has never been recycled or processed before. The GHG emissions associated with the production, use and disposal of fossil-fuel based plastics are forecast to grow to 19% of the global carbon budget by 2040.

It is estimated that 8 million tons of plastic bottles enter our oceans every year and that 14% of littered waste comes from beverage containers. Life-cycle analyses of PET production, waste landfilling and waste incineration of 1 kg of PET bottles needs 176 MJ of energy, results in 6631 g of emissions and has 49 kg CO2 equivalent of GHGs. In contrast, recycling of 1 kg of PET bottle waste needs 27.1 MJ of energy, results in 170 g of emissions and has 1 kg CO2 equivalent of GHGs. If production of recycled PET materials has the same environmental profile as that of vPET, recycling PET and producing bottles with recycled material would need 40% less energy, lower emissions by 61% and result in 93% lower GHGs. Thus, recycling PET and using it in consumer goods would be environmentally beneficial.

Recycling of PET faces limitations in efficiency and economics, resulting in an unadoptable closed-loop system that cannot produce high-quality consumer goods with material properties like petroleum-based vPET. The polymerization of vPET in industrial scale reactors followed by processing during forming allows for precise control of uncontaminated microstructural features that result in tailorable functional properties, leading to their widespread use in consumer applications that need lightweight, strong, and durable materials.

In sharp contrast, recycled PET (rPET) has issues of contamination due to sorting/separating, no ability to tailor microstructures, and has undergone environmental degradation. These issues have prevented the widespread adoption of rPET to replace vPET in applications that need lightweight, strong and durable materials.

Further, rPET feedstocks, the raw materials used to produce rPET, undergo substantial environmental degradation in the marine environment, resulting in breaking up of the polymer chains and loss of functional groups. The functional properties of this degraded rPET cannot compete with those of vPET, and thus adoption in consumer goods that need strength and durability remains limited.

Accordingly, there is a substantial need for a materials innovation that would improve the properties of end-use plastic while maximizing the amount of rPET in a plastic blend to enable wider adoption of rPET for hard consumer goods. Wider adoption of rPET in consumer goods would also incentivize ocean plastic collection, further solving the current environmental crisis of marine plastic pollution.

### BRIEF SUMMARY OF SOME ASPECTS OF THE DISCLOSURE

In some embodiments, the composition is a polyethylene terephthalate (PET) blend composition including virgin polyethylene terephthalate (vPET) and recycled polyethylene terephthalate (rPET). In some embodiments, the composition is a PET blend composition including vPET, rPET, and a polyester-based chain extender. In some embodiments, the composition is a PET blend composition including approximately 25-50% by weight of rPET, approximately 75-47% by weight of vPET, and approximately 0-3% by weight of the polyester-based chain extender.

In some embodiments, a method of manufacturing a PET blend composition comprises drying vPET, rPET and a chain extender into pellets, grinding the rPET and the chain extender pellets together into a mixture, feeding the rPET and the chain extender pellets mixture into an extruder, grinding the rPET and the chain extender pellets mixture through a heated mixing chamber, melting and agitating the rPET and chain extender pellets mixture together into a first extruded material, grinding the first extruded material and vPET pellets together into a mixture, feeding the first extruded material and vPET pellets mixture into an extruder, grinding the first extruded material and vPET pellets mixture through a heated mixing chamber into a second extruded material, and melting the second extruded material.

In some embodiments, a method of injection molding comprises providing a PET blend composition, injecting the composition into molds, forming preform shapes with the second extruded material, annealing the preform shapes at a predetermined temperature until the final shapes reach the predetermined temperature, and cooling the preform shapes to room temperature.

There are other novel aspects and features of this disclosure. They will become apparent as this specification proceeds. Accordingly, this brief summary is provided to introduce a selection of concepts in a simplified form that are further described below in the detailed description. The summary and the background are not intended to identify key concepts or essential aspects of the disclosed subject matter, nor should they be used to constrict or limit the scope of the claims. For example, the scope of the claims should not be limited based on whether the recited subject matter includes any or all aspects noted in the summary and/or addresses any of the issues noted in the background.

### BRIEF DESCRIPTION OF THE DRAWINGS

A further understanding of the nature and advantages of the embodiments may be realized by reference to the following drawings. In the appended figures, similar components or features may have the same reference label.

FIG. 1 illustrates a schematic diagram of an embodiment of a composition in accordance with aspects of the present disclosure.

FIG. 2 is a flow diagram of a method of manufacturing a PET blend composition in accordance with aspects of the present disclosure.

FIG. 3 is a flow diagram of a method of injection molding of hard goods in accordance with aspects of the present disclosure.

FIG. 4 is a graph of Differential Scanning Calorimetry data for glass transition, melt temperatures and enthalpies—(ASTM D3418 and ASTM E793) in three example compositions in accordance with aspects of the present disclosure.

FIG. 5 is a graph of Rheology data for dynamic viscosity (ASTM D4440) in three example compositions in accordance with aspects of the present disclosure.

FIG. 6 is a graph of tensile test data for mechanical properties (ASTM D638) in an example composition in five samples tested in accordance with aspects of the present disclosure.

FIG. 7 is a graph of tensile test data for mechanical properties (ASTM D638) in another example composition in four samples tested in accordance with aspects of the present disclosure.

FIG. 8 is a graph of tensile test data for mechanical properties (ASTM D638) in another example composition in five samples tested in accordance with aspects of the present disclosure.

FIG. 9 is a graph of bending test data for flexural properties (ASTM D790) in an example composition in five samples tested in accordance with aspects of the present disclosure.

FIG. 10 is a graph of bending test data for flexural properties (ASTM D790) in another example composition in five samples tested in accordance with aspects of the present disclosure.

FIG. 11 is a graph of bending test data for flexural properties (ASTM D790) in another example composition in five samples tested in accordance with aspects of the present disclosure.

FIG. 12 is a depiction of sunglasses where the rims and temples are injection molded using the blend described in Example 1.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods disclosed herein relate to, among other things, polyethylene terephthalate (PET) blend compositions and methods for increasing the recyclability of post-consumer plastics waste in injection molded hard goods. This increase in recyclability is accomplished via modifying the chemical and structural make-up of the plastics. For example, the chemical make-up of mineral plastic water and soda bottles can be modified so that the bottles possess melt-flow characteristics and are strengthened upon injection molding to an extent where they become useful for hard and durable goods.

Environmental degradation of recycled PET (rPET) results in degraded melting, flowing, and mechanical properties. The degraded melt-flow makes it impractical for use in injection molding, while the degraded functional properties make it impractical for hard goods. In some embodiments, the disclosed compositions overcome this degradation by combining rPET with vPET and using an extender material to recombine broken polymer chains in rPET.

In the disclosed technology, the resulting microstructure of elongated rPET polymer chains mixed with vPET chains results in melt-flow behavior that makes the pellets amenable to injection molding of hard goods. These properties relate primarily to the crystalline melt temperature, the heat of fusion and the melt dynamic viscosity.

The resulting composite microstructure also ensures that once injection molded, the goods will have the mechanical properties needed for the goods to perform well as durable hard goods. These mechanical properties are related to the tensile strength, flexural strength, shore hardness, tensile modulus, flexural modulus, and elongation at break. These excellent properties relate to the rate of crystallization of the microstructure that can be tuned easily by controlling the mold temperature during the injection molding process.

In some embodiments, the PET blend compositions described herein use more than 25% by weight of rPET combined with vPET and an optional additive chain extender to create pellets that can be used in injection molding modalities to create durable hard consumer goods whose functional performance is on par with current petroleum-based vPET. The PET blend compositions are over 10 times more sustainable than current rPET options. The larger use of rPET from plastic bottle waste removes the carbon emissions associated with the production and use of vPET while also removing the PET plastic waste from the environment. The vPET and rPET, and the polyester-based chain extender are all available commercially.

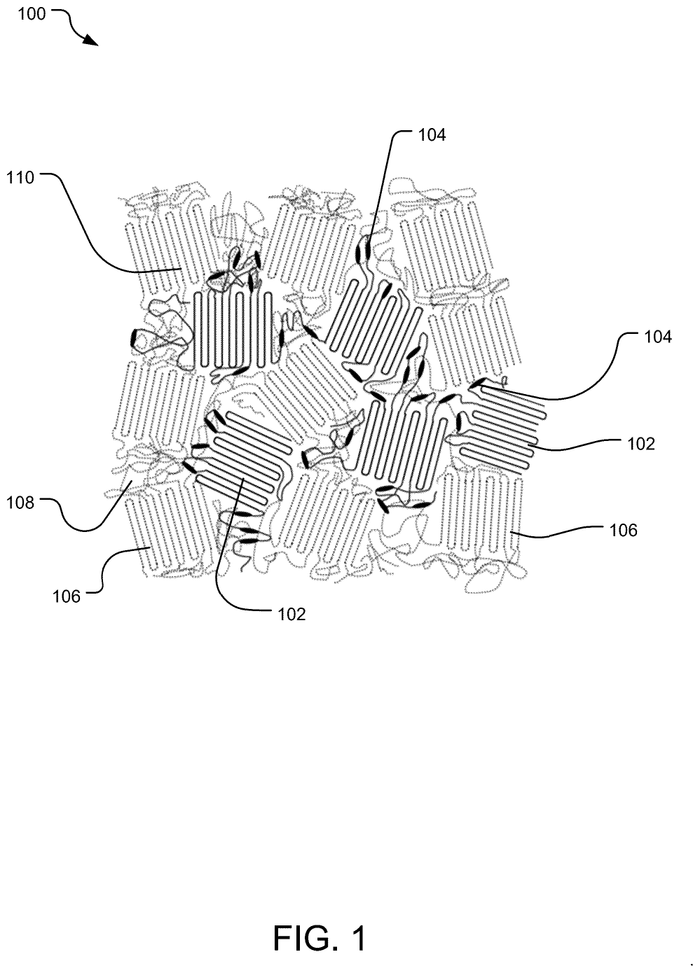

In some embodiments, the PET blend composition is a polyester-based polymer composition comprised of 25-50% by weight of post-industrial and post-consumer recycled polyethylene terephthalate (rPET), 49.25-75% by weight of petroleum-based virgin PET (vPET), and 0-1.5% by weight of a polyester extender material. The PET blend composition has a microstructure, as shown in FIG. 1, that consists of rPET polymer chains 102 that are interconnected via the polyester-based extender 104, mixed with virgin PET polymer chains 106, both of which can exist as crystalline nodes interconnected by amorphous chains.

In some embodiments, the PET blend composition described herein has properties that make them particularly suitable for injection-molding (IM), possessing a dynamic viscosity between 76-319 Pa·s and a melt temperature between 240-250° C. Thick goods or objects injection-molded from the PET blend compositions exhibit good clarity and aesthetics. For purposes of this disclosure, the term thick refers to a minimum dimension of 2 mm on an injection-molded portion. Additionally, these objects present excellent thermo-mechanical properties that make them ideal for use in durable consumer articles. These thermo-mechanical properties are a tensile strength of at least 48 MPa, a flexural strength of at least 77 MPa, a shore D hardness of at least 73, tensile modulus of at least 2.1 GPa, flexural modulus of at least 2.2 GPa, and a tensile elongation of break of at least 191%. The durability and strength of these injection molded articles is due to the re-strengthening of degraded rPET polymer chains from plastic bottles via interconnections created by a polyester-based extender molecule. Both the extended rPET and virgin PET chains inter-tangle with each other during the formation process. Thus, these injection-molded products end up containing 25-50% by weight of recycled material in them. This material helps solve the issue of unrecycled plastic waste that plagues the earth by removing it from the waste stream to create materials that contain more than 25% of recycled material in them for use in consumer articles produced via injection molding. This material has thermal and mechanical properties that allow it to replace virgin PET material in consumer articles.

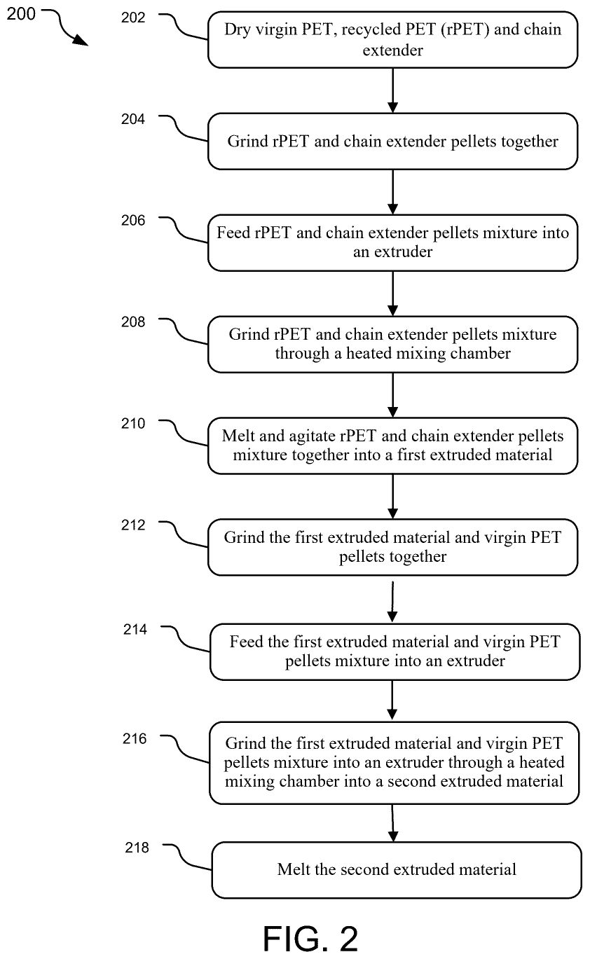

FIG. 2 is a flowchart for method of manufacturing a PET blend composition. An operation 202 dries vPET, rPET and a chain extender into pellets. The vPET, rPET and the chain extender may be dried in an inert atmosphere. In some embodiments, the vPET, the rPET and the chain extender are dried in an inert atmosphere of 99.9% pure nitrogen for a minimum of 48 hours to ensure there is no moisture.

An operation 204 grinds and mixes the rPET and the chain extender pellets together into a mixture. An operation 206 feeds the rPET and the chain extender pellets mixture into an extruder.

An operation 208 grinds the rPET and the chain extender pellets mixture. The grinding may occur through a heated mixing chamber. In some embodiments, the ground mixture is put into the extruder, where the hopper and the screw drive the ground mixture through a heated mixing chamber at approximately 270° C.

An operation 210 melts and agitates the rPET and chain extender pellets mixture together into a first extruded material. In some embodiments, the amount of time for the mixture to melt and agitate together and then get extruded is approximately 7 minutes. An operation 212 grinds the first extruded material and vPET pellets together into a mixture. An operation 214 feeds the first extruded material and vPET pellets mixture into an extruder.

An operation 216 grinds the first extruded material and vPET pellets mixture into a second extruded material. The grinding may occur through a heated mixing chamber. In some embodiments, the ground mixture is put into the extruder, where the hopper and the screw drive the ground mixture through a heated mixing chamber at approximately 270° C.

An operation 218 melts the second extruded material into a polyester-based polymer composition (PET blend composition). The amount of time for the mixture to melt and agitate together and then undergo extrusion is 7 minutes.

The original rPET degraded chains are elongated via a polyester-based chain extender via supramolecular bonding. These elongated rPET polymer chains then intermingle with vPET polymer chains to create a composite polyester microstructure. This resulting microstructure improves the melt-flow behavior of degraded rPET, making this composite polyester blend suitable for injection molding.

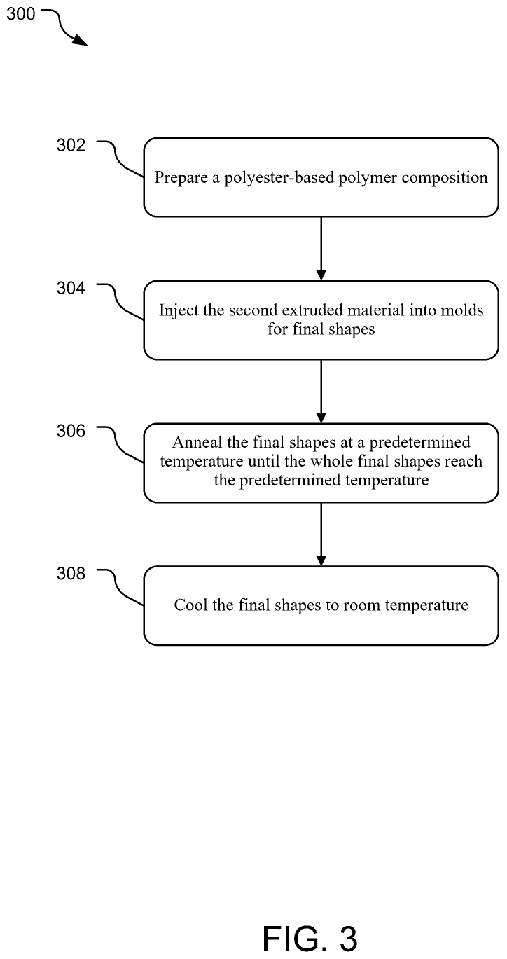

FIG. 3 is a flowchart for method 300 of injection molding. The method 300 includes using pellets of the disclosed PET blend compositions for injection molding of hard goods.

An operation 302 provides a PET blend composition. The PET blend composition may be any PET blend composition described in detail throughout this disclosure, including in FIGS. 1 and 2.

An operation 304 injects the PET blend composition, or more specifically, the second extruded material of FIG. 1, into molds. An operation 306 forms preform shapes with the second extruded material. An operation 308 anneals the preform shapes at a predetermined temperature until to form final shapes until the final shapes reach the predetermined temperature. An operation 310 cools the preform shapes to room temperature.

Once injection-molded into a mold for final shape, the percent crystallinity and amorphousness in the microstructure is easily tuned by adjusting the mold temperature to optimize the final form mechanical properties according to the application.

In some embodiments, the PET blend compositions have the melt-flow characteristics necessary for injection molding of this blend for hard consumer articles (for e.g. sunglasses, components of ski goggles, buckles and trims, decorative components, toys, pet gear) that have 25-50% by weight of rPET in them. The melt flow behavior is characterized via ASTM D3418 standard—Standard Test Method for Transition Temperatures and Enthalpies of Fusion and Crystallization of Polymers by Differential Scanning Calorimetry, and ASTM D4440—Standard Test Method for Plastics: Dynamic Mechanical Properties Melt Rheology. The melt-flow properties related to injection molding are a dynamic viscosity between 76-319 Pa·s and a melt temperature between 240-250° C. The result of the injection molding process is a thick good, whose smallest dimension is at least 2 mm. The injection molding is performed adhering to the standard ASTM D6341—Standard Practice for Injection Molding Test Specimens of Thermoplastic Molding and Extrusion Materials.

In some embodiments, the PET blend composition has the thermal and mechanical properties necessary for use of this blend for hard consumer articles (for e.g. sunglasses, components of ski goggles, buckles and trims, decorative components, toys, pet gear and others) that have 25-50% by weight of rPET in them. The thermal property primarily relates to the glass transition temperature, which is established via the ASTM D3418 Standard—Standard Test Method for Transition Temperatures and Enthalpies of Fusion and Crystallization. The mechanical properties are primarily related to the tensile strength, flexural strength, shore hardness, tensile modulus, flexural modulus, and elongation at break. For the mechanical properties, tensile testing is established via the ASTM D638 Standard—Standard Test Method for Tensile Properties of Plastics, flexural testing is performed following ASTM D790—Standard Test Methods for Flexural Properties of Unreinforced and Reinforced Plastics and Electrical Insulating Materials, and the Shore D Hardness is found following ASTM D2240—Durometer Hardness.

The following Examples provide a framework to implement various aspects of the disclosure, and these Examples do not limit any aspect of the disclosure or any patent claim that matures from this patent document.

### Example 1

A polyester masterbatch for injection molding was prepared using 75% by weight vPET, 25% by weight rPET and no extender.

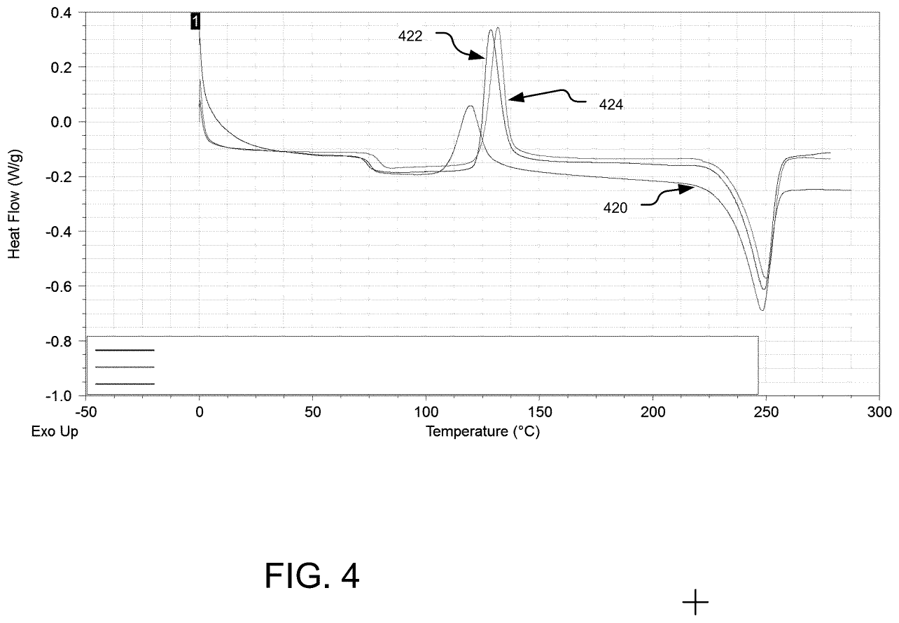

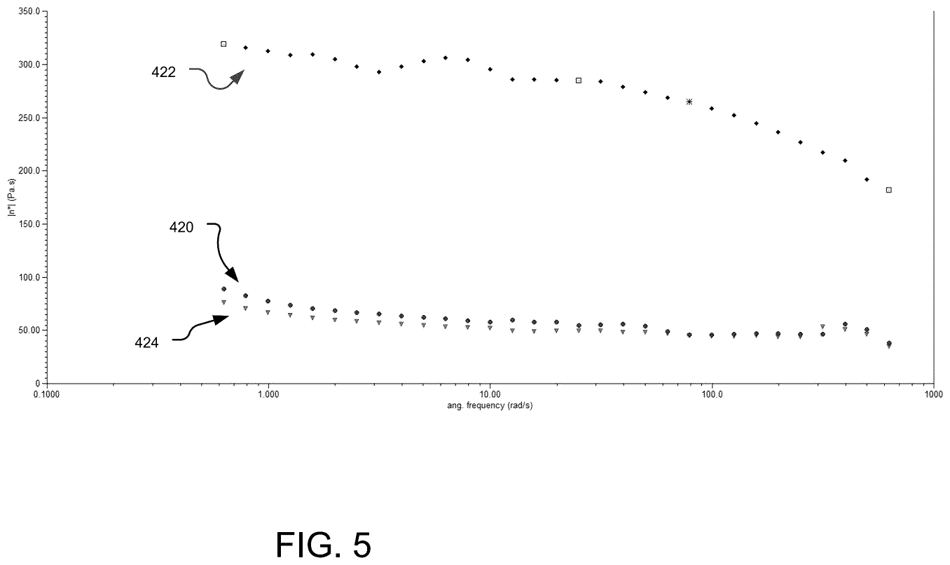

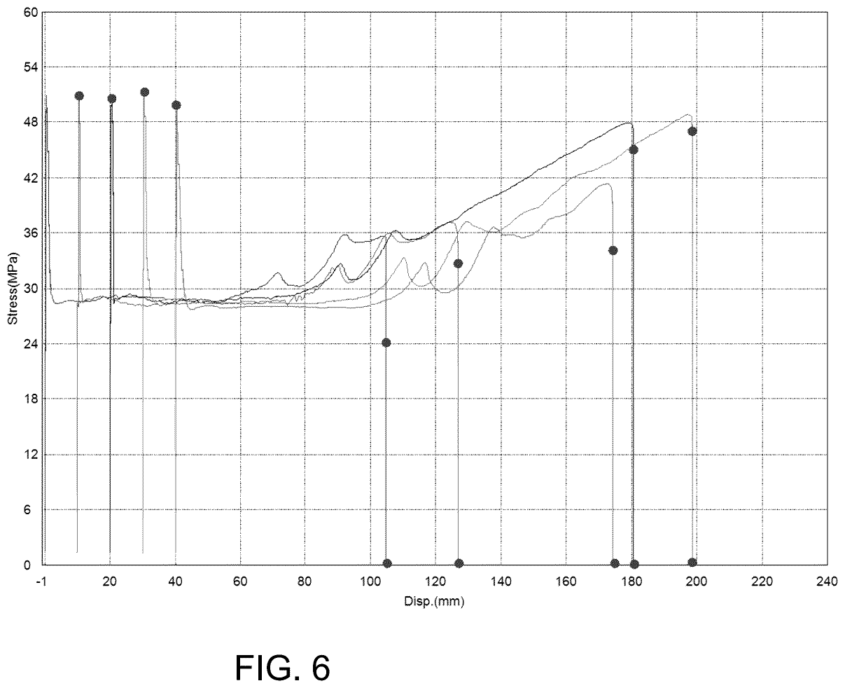

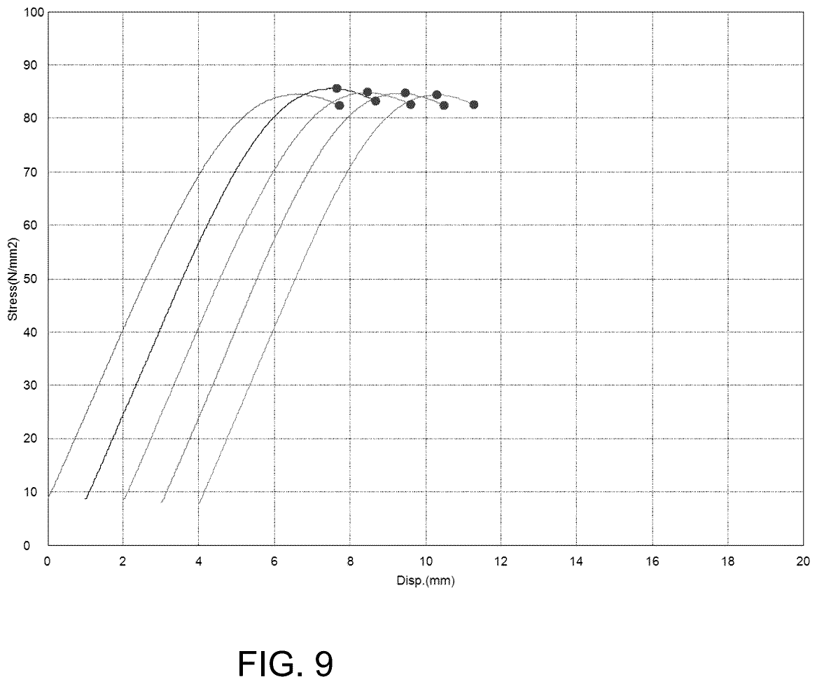

Differential Scanning Calorimetry (DSC) data, Rheology data for dynamic viscosity, tensile test data for mechanical properties, and bending test data for flexural properties for Example 1 is shown in FIGS. 4, 5, 6, and 9, and labeled in FIGS. 1 and 2 as 420.

DSC measured that the rate of change of temperature was 10° C./min and the samples were heated from 0 to 280° C. in Example 1, as shown in FIG. 4 at 420.

For injection molding of tensile and flexural bars, the barrel temperature was 264° C., an injection pressure of 190 Bar, a hold pressure of 80 Bar, an A side mold temperature of 77° C. and a B side mold temperature of 4° C. (cooled with ice water). The injection molded tensile samples, and flexural samples had a minimum thickness dimension of 3.3 mm. For the tensile tests, the actuator testing speed was 5 mm/in with a pre-load of 35 N and for the flexural tests the actuator testing speed was 1.47 mm/min with a pre-load of 35 N. The data

The blended pellets and injection molded test parts produced the following results:

| Property | Test Spec. | Value | Unit | Tolerance |
|---|---|---|---|---|
| Crystalline Peak Melting | ASTM D 3418 | 248 | ° C. | ±5° C. |
| Point | | | | |
| Glass Transition (Onset) | ASTM D 3418 | 73 | ° C. | ±3° C. |
| Heat of Fusion | ASTM E793 | 38.1 | J/g | — |
| Dynamic Viscosity @ | ASTM D4440 | 88 | Pa · s | ±2 |
| 270° C. | | | | |
| Ultimate Tensile Strength | ASTM D638 | 48.85 | MPa | ±5 |
| Tensile Modulus | ASTM D638 | 2.28 | GPa | ±0.1 |
| Elongation at Break | ASTM D638 | 292 | % | ±10% |
| Ultimate Flexural Strength* | ASTM D790 | 78.65 | MPa | ±3 |
| Flexural Modulus | ASTM D790 | 2.27 | GPa | ±0.12 |
| Shore D Hardness | ASTM D2240 | 73.4 | — | — |

*Flexural samples tested did not fail by the 5% strain limit imposed by ASTM D790, tested by both Procedure A and Procedure B loading methods.

### Example 2

A polyester masterbatch for injection molding was prepared using 49.25% by weight vPET, 49.25% by weight rPET and 1.5% by weight of extender.

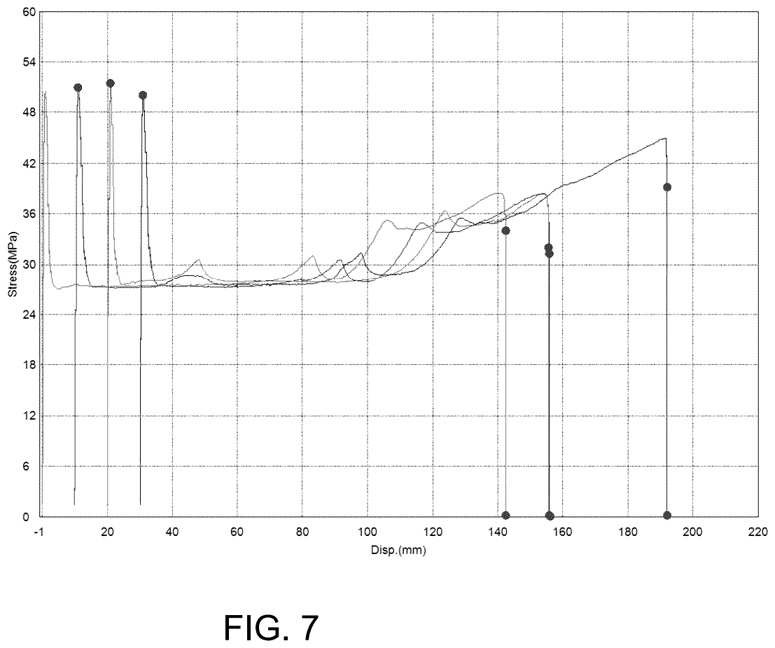

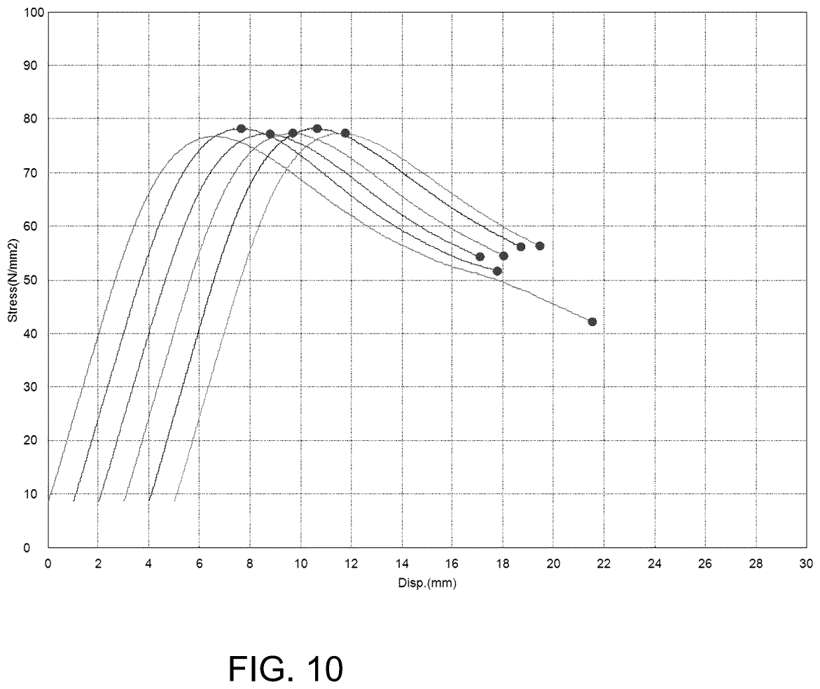

DSC data, Rheology data for dynamic viscosity, tensile test data for mechanical properties, and bending test data for flexural properties for Example 2 are shown in FIGS. 4, 5, 7, and 10, and labeled in FIGS. 1 and 2 as 422.

DSC measured that the rate of change of temperature was 10° C./min and the samples were heated from 0 to 280° C. in Example 1, as shown in FIG. 4 at 422.

For injection molding of tensile and flexural bars, the barrel temperature was 267° C., an injection pressure of 200 Bar, a hold pressure of 80 Bar, an A side mold temperature of 75° C. and a B side mold temperature of 4° C. (cooled with ice water). The injection molded tensile samples, and flexural samples had a minimum thickness dimension of 3.3 mm. For the tensile tests, the actuator testing speed was 5 mm/in with a pre-load of 35 N and for the flexural tests the actuator testing speed was 1.47 mm/min with a pre-load of 35 N.

The blended pellets and injection molded test parts produced the following results:

| Property | Test Spec. | Value | Unit | Tolerance |
|---|---|---|---|---|
| Crystalline Peak Melting | ASTM D 3418 | 249.17 | ° C. | ±5° C. |
| Point | | | | |
| Glass Transition (Onset) | ASTM D 3418 | 71.48 | ° C. | ±3° C. |
| Heat of Fusion | ASTM E793 | 40.16 | J/g | — |
| Dynamic Viscosity @ | ASTM D4440 | 319 | Pa · s | ±2 |
| 270° C. | | | | |
| Ultimate Tensile Strength | ASTM D638 | 49.3 | MPa | ±5 |
| Tensile Modulus | ASTM D638 | 2.13 | GPa | ±0.1 |
| Elongation at Break | ASTM D638 | 191 | % | ±10% |
| Ultimate Flexural Strength* | ASTM D790 | 77.5 | MPa | ±3 |
| Flexural Modulus | ASTM D790 | 2.28 | GPa | ±0.12 |
| Shore D Hardness | ASTM D2240 | 74 | — | — |

*Flexural samples tested did not fail by the 5% strain limit imposed by ASTM D790, tested by both Procedure A and Procedure B loading methods.

### Example 3

A polyester masterbatch for injection molding was prepared using 50% by weight vPET, 50% by weight rPET and no extender.

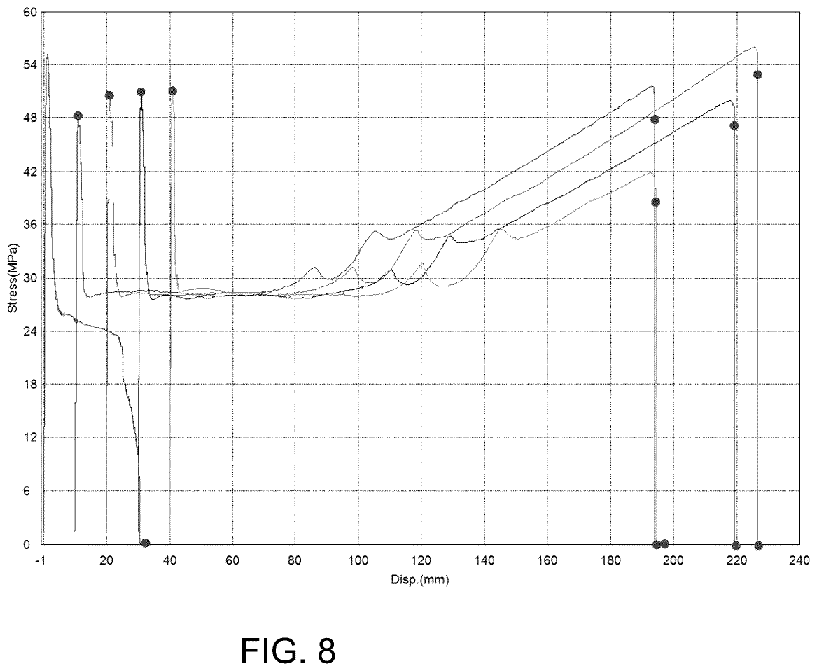

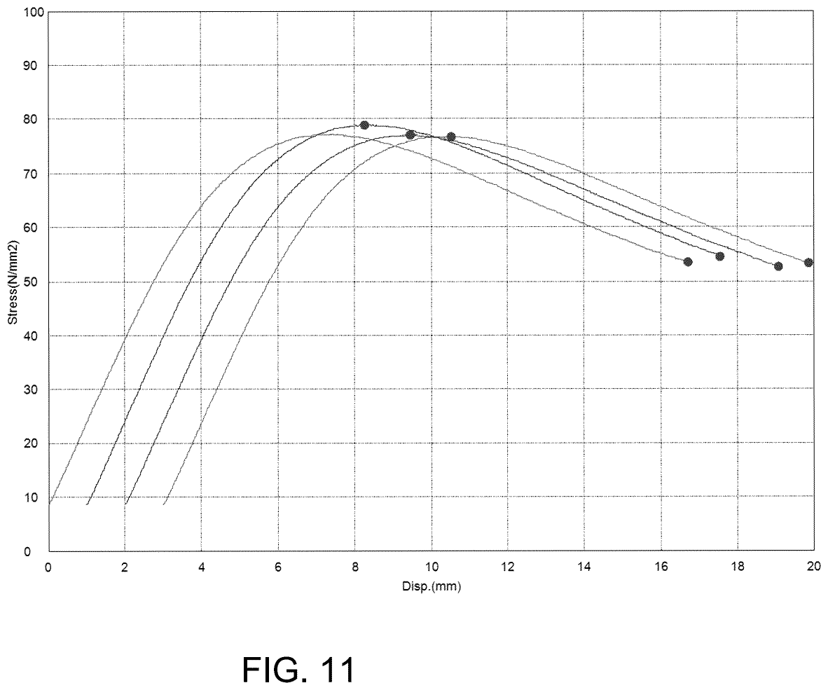

DSC data, Rheology data for dynamic viscosity, tensile test data for mechanical properties, and bending test data for flexural properties for Example 3 are shown in FIGS. 4, 5, 8, and 11, and labeled in FIGS. 1 and 2 as 424.

DSC measured that the rate of change of temperature was 10° C./min and the samples were heated from 0 to 280° C., as shown in FIG. 4 at 424.

For injection molding of tensile and flexural bars, the barrel temperature was 265° C., an injection pressure of 185 Bar, a hold pressure of 90 Bar, an A side mold temperature of 75° C. and a B side mold temperature of 4° C. (cooled with ice water). The injection molded tensile samples, and flexural samples had a minimum thickness dimension of 3.3 mm. For the tensile tests, the actuator testing speed was 5 mm/in with a pre-load of 35 N and for the flexural tests the actuator testing speed was 1.47 mm/min with a pre-load of 35 N.

The blended pellets and injection molded test parts produced the following results:

| Property | Test Spec. | Value | Unit | Tolerance |
|---|---|---|---|---|
| Crystalline Peak Melting | ASTM D 3418 | 251 | ° C. | ±5° C. |
| Point | | | | |
| Glass Transition (Onset) | ASTM D 3418 | 72.48 | ° C. | ±3° C. |
| Heat of Fusion | ASTM E793 | 48.62 | J/g | — |
| Dynamic Viscosity @ | ASTM D4440 | 76.33 | Pa · s | ±2 |
| 270° C. | | | | |
| Ultimate Tensile Strength | ASTM D638 | 50.18 | MPa | ±5 |
| Tensile Modulus | ASTM D638 | 2.21 | GPa | ±0.1 |
| Elongation at Break | ASTM D638 | 287 | % | ±10% |
| Ultimate Flexural Strength* | ASTM D790 | 77.45 | MPa | ±3 |
| Flexural Modulus | ASTM D790 | 2.23 | GPa | ±0.12 |
| Shore D Hardness | ASTM D2240 | 73.8 | — | — |

*Flexural samples tested did not fail by the 5% strain limit imposed by ASTM D790, tested by both Procedure A and Procedure B loading methods.

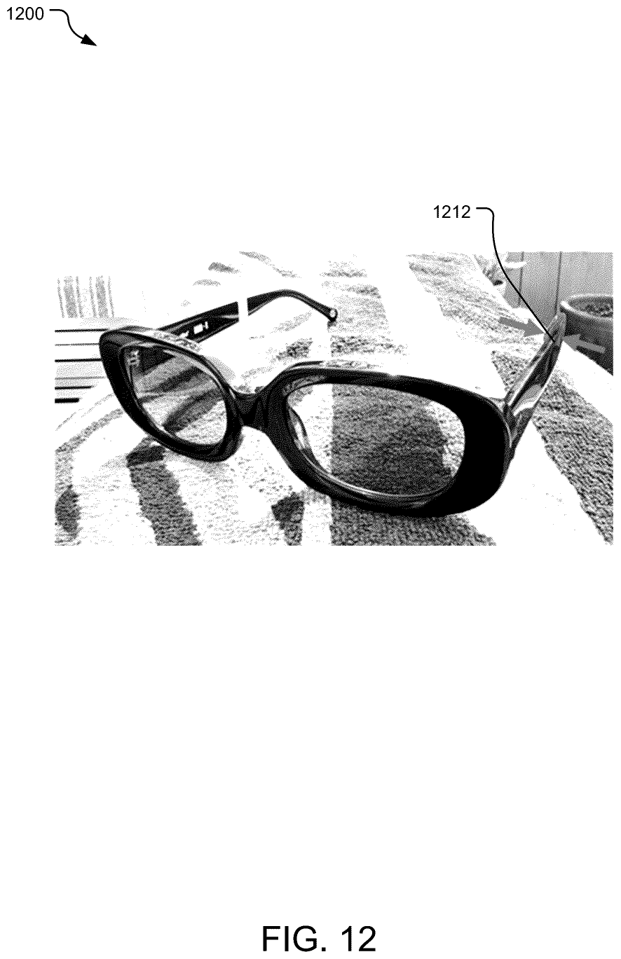

The blend in Example 1 was used to mold the rims and temples of sunglasses 1200 with a black color additive, as shown in FIG. 12. The minimum dimension was in the temple thickness which is 2.5 mm thick in the location 1212 shown.

It should be well understood that the examples disclosed herein, such as those described with reference to FIGS. 4-11 are merely exemplary embodiments. The concepts illustratively disclosed suitably may be practiced in the absence of any element which is not specifically disclosed herein. It is apparent to those skilled in the art that many changes, variations, modifications, other uses, and applications of the disclosure are possible, and changes, variations, modifications, other uses, and applications which do not depart from the spirit and scope of the disclosure are deemed to be covered by the disclosure. Thus, various embodiments may omit, substitute, or add various procedures or components as appropriate. For instance, it should be appreciated that the methods, for example as described in FIGS. 2 and 3, may be performed in an order different than that described, and that various steps may be added, omitted or combined. Also, aspects and elements described with respect to certain embodiments may be combined in various other embodiments. It should also be appreciated that the following methods may individually or collectively be components of a larger system, wherein other procedures may take precedence over or otherwise modify their application. The foregoing discussion has been presented for purposes of illustration and description.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.”

The detailed description includes specific details for the purpose of providing an understanding of the described techniques. These techniques, however, may be practiced without these specific details. In some instances, well-known structures and devices are shown in block diagram form in order to avoid the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

### Terminology and Interpretative Conventions

Any methods described in the claims or specification should not be interpreted to require the steps to be performed in a specific order unless stated otherwise. Also, the methods should be interpreted to provide support to perform the recited steps in any order unless stated otherwise.

Spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The terms have, having, include, and including should be interpreted to be synonymous with the terms comprise and comprising. The use of these terms should also be understood as disclosing and providing support for narrower alternative embodiments where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in either direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any embodiment, feature, or combination of features described or illustrated in this document. This is true even if only a single embodiment of the feature or combination of features is illustrated and described in this document.

1. A method of manufacturing a PET blend composition, comprising:
drying virgin PET (vPET), recycled PET (rPET) and a chain extender into pellets;
grinding the rPET and the chain extender pellets together into a mixture;
feeding the rPET and the chain extender pellets mixture into an extruder;
grinding the rPET and the chain extender pellets mixture;
melting and agitating the rPET and chain extender pellets mixture together into a first extruded material;
grinding the first extruded material and vPET pellets together into a mixture;
feeding the first extruded material and vPET pellets mixture into an extruder;
grinding the first extruded material and vPET pellets mixture through a heated mixing chamber into a second extruded material; and
melting the second extruded material.

2. The method of claim 1, wherein the vPET, rPET, and the chain extender are dried in an inert atmosphere of approximately 99.9% pure nitrogen for a minimum of 48 hours.

3. The method of claim 1, wherein grinding the rPET and the chain extender pellets mixture and grinding the first extruded material and vPET pellets mixture is performed through a heated mixing chamber.

4. The method of claim 1, wherein the heated mixing chamber is approximately 270° C.

5. The method of claim 1, wherein the rPET blend composition includes:
approximately 25-50% by weight of rPET.

6. The method of claim 1, wherein the rPET blend composition includes:
approximately 25-50% by weight of rPET;
approximately 75-47% by weight of vPET; and
approximately 0-3% by weight of a polyester-based chain extender.

7. The method of claim 1, wherein the vPET is petroleum-based vPET.

8. A method of injection molding, comprising:
providing a PET blend composition;
injecting the PET blend composition into molds;
forming preform shapes with the PET blend composition;
annealing the preform shapes at a predetermined temperature;
forming final shapes that reach the predetermined temperature; and
cooling the final shapes to room temperature.

9. The method of claim 8, wherein the preform shapes are annealed at approximately 120° C.

10. The method of claim 8, wherein the PET blend composition includes:
virgin PET (vPET); and
recycled PET (rPET).

11. The method of claim 10, further comprising:
a polyester-based chain extender.

12. The method of claim 8, wherein the PET blend composition includes:
approximately 25-50% by weight of rPET.

13. The method of claim 11, wherein the PET blend composition includes:
approximately 25-50% by weight of rPET;
approximately 75-47% by weight of vPET; and
approximately 0-3% by weight of the polyester-based chain extender.

14. The method of claim 8, wherein the preform shapes have a minimum dimension of 2 mm.

15. The method of claim 10, wherein the vPET is petroleum-based vPET.

16. A PET blend composition comprising:
virgin PET (vPET); and
recycled PET (rPET).

17. The PET blend composition of claim 16, further comprising:
a polyester-based chain extender.

18. The PET blend composition of claim 16, comprising:
approximately 25-50% by weight of rPET.

19. The PET blend composition of claim 17, comprising:
approximately 25-50% by weight of rPET;
approximately 75-47% by weight of vPET; and
approximately 0-3% by weight of the polyester-based chain extender.

20. The PET blend composition of claim 16, wherein the composition has a dynamic viscosity between 76-319 Pa·s and a melt temperature between 240-250° C.
